(19) United States
(12) Patent Application Publication
(10) Pub. No.: US 2008/0186172 A1
(43) Pub. Date: Aug. 7, 2008

(54) INTRUSION DETECTION SYSTEM FOR ELECTRIC FENCES

(76) Inventor: Paul Thompson, Narrangba (AU)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 12/024,316

(22) Filed: Feb. 1, 2008

Related U.S. Application Data
(60) Provisional application No. 60/887,731, filed on Feb. 1, 2007.

(51) Int. Cl. G08B 13/00

(52) U.S. Cl. 340/541

(57) ABSTRACT

An energizer for an electric fence having a wire with feed and return terminals. The energizer includes a high voltage pulse generator for generating high voltage pulses at the feed terminal and a low voltage circuit for providing a low voltage signal at the feed terminal and for monitoring any changes in the low voltage signal at the return terminal to determine if the wire of the fence is touched, or if a short circuit or open circuit exists. An impedance decouples the high voltage pulses from the low voltage circuitry. The low voltage circuit makes measurements of electrical characteristics of the wire between the high voltage pulses. A low voltage intrusion detection system and related methods are also disclosed.

### CROSS-REFERENCE TO RELATED PATENT APPLICATION

This patent application is a non-provisional patent application of U.S. provisional patent application Ser. No. 60/887,731, filed on Feb. 1, 2007, the right of priority of which is claimed for this patent application.

### FIELD OF THE INVENTION

The present invention relates to an intrusion detection system and in particular to electric fences and electric fence energizers.

### BACKGROUND OF THE INVENTION

Electric fences are often for security purposes to restrict unauthorized entry to certain areas such as industrial premises. They are also used for containment in detention centers and for livestock and agricultural purposes.

Electric fences normally include a number of posts from which numerous non-insulated wire conductors are strung such that the conductors are insulated from the posts and therefore the ground. The conductors are coupled to an energizer that periodically outputs a high voltage pulse to energize the conductors so that intruders will receive a small electric shock if they contact the energized conductors. While the voltage may be very high, such as up to 10,000 Volts peak, the time of the pulse is very short in order to be safe, typically on the order of 100 microseconds. The pulse rate is also limited by international safety standards, such as IEC60335.2.76, to no more than one pulse per second.

The intruder receives a shock by completing the circuit from the energizer, via the live wires to ground and back to the energizer ground terminal. The spacing and height of the wires is such that it is difficult to gain access to the protected area without contacting the wires. The live wires are often interleaved with grounded wires so as to make a circuit even if the intruder attempts to insulate him or herself from the ground but touches more than one wire. If the wires are cut or shorted to ground, a monitoring circuit connected to the electrical “end” of the live wires, detects the change in voltage and can sound an alarm or trigger a call to a guard center. This monitoring is typically achieved by measuring the peak voltage. If the peak voltage falls below a predetermined threshold at the fence, an alarm is generated.

Under international safety standards, such as IECG0335.2.76, the energizers are limited to pulses at a rate of one hertz. Since the detection is therefore also limited to this rate, the fence could be shorted quickly in between two pulses and it would not be detected. In practice, the detection is even slower due the need to stop false alarms. Thus, typical systems are set to alarm after three missing or bad pulses. It is therefore possible for an individual to touch the fence, and not generate an alarm, even though they receive one or more shocks.

In an agricultural fence, the time of one second or more between pulses means that a fast moving animal may be most of the way through the fence before it receives a shock.

Many security electric fences are used in situations where employees or the general public are allowed to access the area at certain times, such as during the day. In this case, the energizer may be turned off during that time. Problems may arise when the electric fence conductors can be manipulated or damaged when the energizer is off since the monitoring system is then incapable of detecting the problem. A would-be intruder could compromise the fence during this time in order to defeat the detection of a planned later intrusion. Also damage to the fence will only be noticed when the system is armed again. For industrial premises, this typically occurs when the manager is attempting to close up for the evening. To overcome this problem, some security electric fence energizers reduce the power levels in the high voltage pulse generator circuit to provide a lower voltage mode. This reduces the effective shock but still allows the fence to be monitored. In some cases, these lower voltage pulses are still unacceptably high, such as on the order of several hundred volts peak. This may be the effective lower limits of operation of the pulse generator and or monitor, whose primary functions are respectively to produce and measure 10 kV pulses.

Some other systems run a very low voltage of either AC or DC from a power source through the ground wire grid, and back to a monitoring input. Such systems can run at less than 60 volts and so be classified as extra low voltage (ELV), which is considered totally safe. While this is capable of detecting gross damage to the fence, it cannot detect all faults with the fence since these low voltage systems are usually merely measuring continuity of the ground conductors. The reason that the ground circuit is chosen is that it is technically difficult to combine both a very low voltage and the conventional very high voltage pulse generator outputs onto the same fence circuit. This is due to the fact that the output transformer of the pulse generator has a low impedance at the favored frequencies of the low voltage systems. It therefore would present an unacceptable load on the low voltage power source.

Improvements in electric fencing over recent years include all live wire systems introduced whereby, instead of alternating live and grounded wires on the fence, there are two polarities or phases of live wires. This increases the likelihood of the intruder being deterred and or detected. However, since there is no ground or earthed conductors in these fences, a prior art low voltage detection circuit cannot be added.

It is generally considered unsafe to use electric fences in a classified hazardous area.

It is therefore an object of the present invention to provide an electric fence electric energizer and a low voltage detection system that overcome, or at least ameliorate, one or more of the deficiencies of the prior art electric fence energizers mentioned above.

It is also an object of the present invention to provide the consumer with a useful or commercial choice in electric fence energizers.

### SUMMARY OF THE INVENTION

According to a first aspect of the present invention, there is provided a low voltage signal source and monitoring system capable of detecting changes in the electrical characteristics of wires insulated from ground arranged in such a way as to form a barrier or fence to detect the presence of an individual or animal. The system includes a power source, a signal generator and a monitoring circuit, fence feed, return and ground terminals and a controller to coordinate the measurement of the characteristics of the wires.

The low voltage detection system can detect both an individual touching the live wire as well as a complete short circuit between one live wire and ground or an open circuit in the fence wires connected between the feed and the return terminals.

The system may alternatively combine the feed and return terminals and forego the ability to differentiate between an open circuit and a short circuit.

The system may be made with voltage and current levels low enough to be considered intrinsically safe under the standards that control the use of electrical equipment in classified hazardous areas, such as Underwriters Laboratories standard UL913.

According to a second aspect of the invention, there is provided a security electric fence energizer for energizing the conductors of a security electric fence. The energizer includes a high voltage pulse generator. The energizer also includes a low voltage signal source and monitoring system capable of detecting changes in the electrical characteristics of the fence wires when an intruder contacts the wires. The low voltage system can detect an individual touching the live wire as well as a complete short circuit between one live wire and ground or an open circuit in the fence wires connected between the feed and the return terminals.

The present invention also includes methods of combining the output of the high voltage generator and the low voltage signal source onto the same fence output terminals and the high voltage monitor and low voltage monitor onto the same return terminals. The methods also include decoupling the pulse generator output transformer from the fence output terminals so as to not load down the low voltage signal. The methods further include protecting the sensitive circuitry of the low voltage monitor from the very high voltages of the conventional electric fence pulses without loading the high voltage down. The low voltage system measures the fence characteristics at a rapid rate enabling the detection of an intruder between the high voltage deterrent pulses.

The energizer may also include a controller to coordinate the activity of the high voltage and low voltage systems and to analyze the results of the measurements of the high voltage and low voltage monitoring systems. The logic and algorithms of this controller may be programmed to automatically make adjustment to the presence or power level of the deterrent pulses depending on the results of measurements made by the low voltage system.

The energizer may include a number of channels, each with its own set of feed and return terminals. The energizer may include a number of channels that can be combined onto the alternating live wires of one fence with synchronised high voltage pulses of the same or opposite polarity voltages.

The energizer may also include conventional high voltage monitoring circuitry and a controller to compare the results of the measurements of both the high and low voltage monitors to discriminate between a number of predetermined levels such as a minor problem, trouble and a full alarm.

The low voltage system according to this invention may be made as separate module for connection to an electric fence that is separately energized with a conventional high voltage electric fence energizer.

According to another aspect of the invention there is provided an electric fence energizer as per the second aspect above for energizing the conductors of an agricultural electric fence.

### BRIEF DESCRIPTION OF THE DRAWINGS

In order that this invention may be more readily understood and put into practical effect, reference will now be made to the accompanying drawings which illustrate typical preferred embodiments of the invention and wherein:

FIG. 1 is a diagrammatic view of a security electric fence according to the preferred embodiment of the present invention.

FIG. 2 is a simplified schematic diagram of a security electric fence energizer according to an embodiment of the present invention.

FIG. 3 is a simplified schematic of a low voltage intrusion detection system according to an embodiment of the present invention.

FIG. 4A is a diagrammatic view of an intruder contacting one or more conductors in the electric fence.

FIG. 4B is a schematic diagram showing an equivalent electrical circuit of an electric fence.

### DETAILED DESCRIPTION OF THE INVENTION

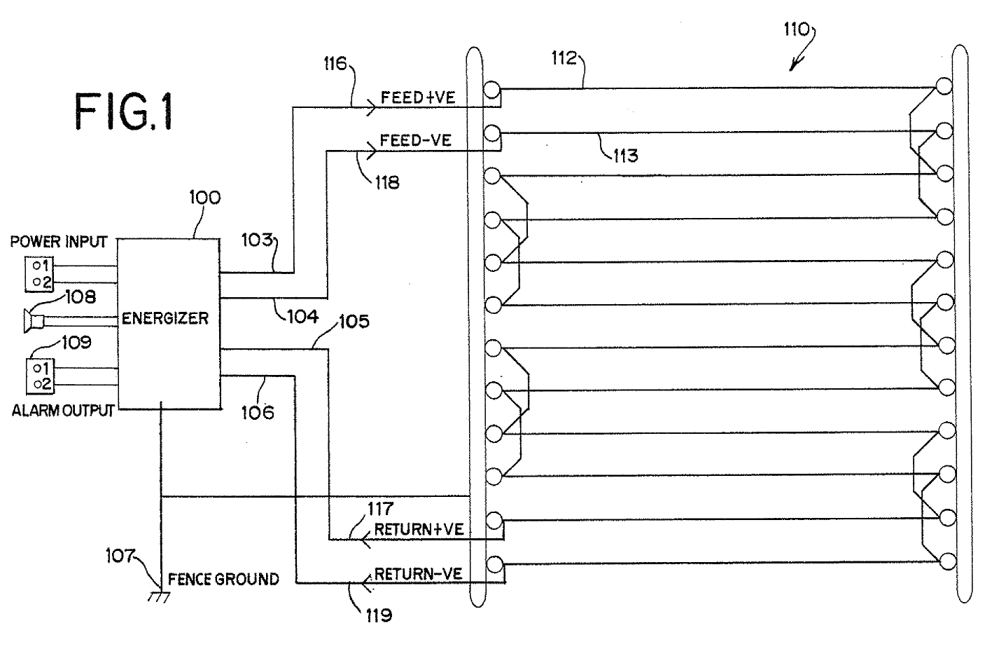

A diagrammatic view of a security electric fence, including a circuit schematic diagram, according to the preferred embodiment of the present invention is depicted in FIG. 1. An energizer 100 includes output terminals 103-106 to conduct both high voltage signals and low voltage signals onto the electric fence wires. The fence 110 contains two sets of live wires 112 and 113. A first “positive” channel runs from the positive feed terminal 116 to the fence 110, then down the fence 110 in an alternating pattern with the wires 112 to negative feed terminal 117. The positive wires terminate back to the positive return terminal 105. In similar fashion, A first “negative” channel runs from the negative feed terminal 118 to the fence 110, then down the fence 110 in an alternating pattern with the wires 113 to negative feed terminal 119. The negative wires terminate back to the negative return terminal 106. The energizer 100 also has a fence ground connection 107.

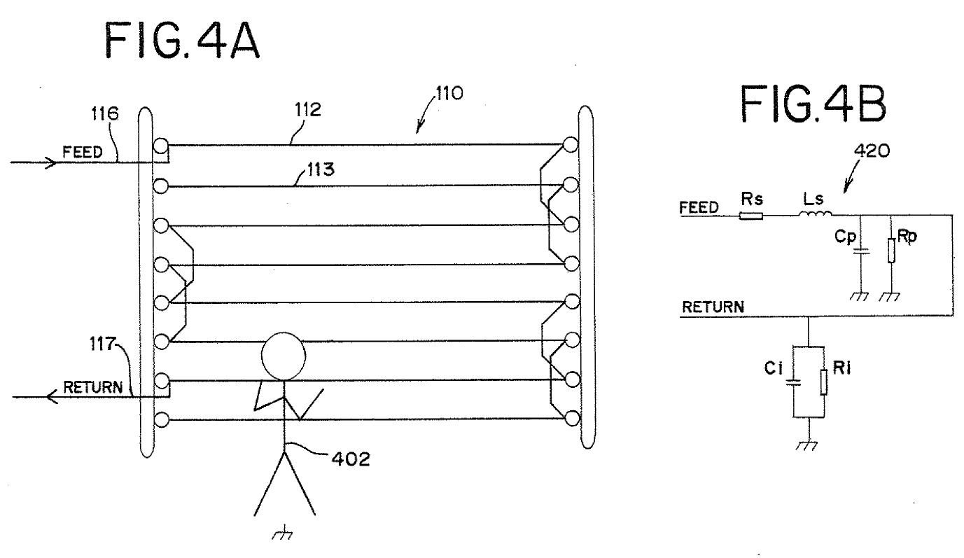

When the energizer detects a problem with the fence, the alarm is sounded via a siren 108. Another signal is sent via a connection 109 to another supervisory alarm system (not shown). FIG. 4B shows the equivalent circuit 420 of an electric fence 110. The fence wire 112 or 113 has series resistance Rs, series inductance Ls, capacitance with respect to ground Cp and leakage resistance Rp. When an intruder 402 in FIG. 4A touches the wire 112 they add capacitance Ci and leakage resistance Ri. This alters the electrical properties of the fence 110.

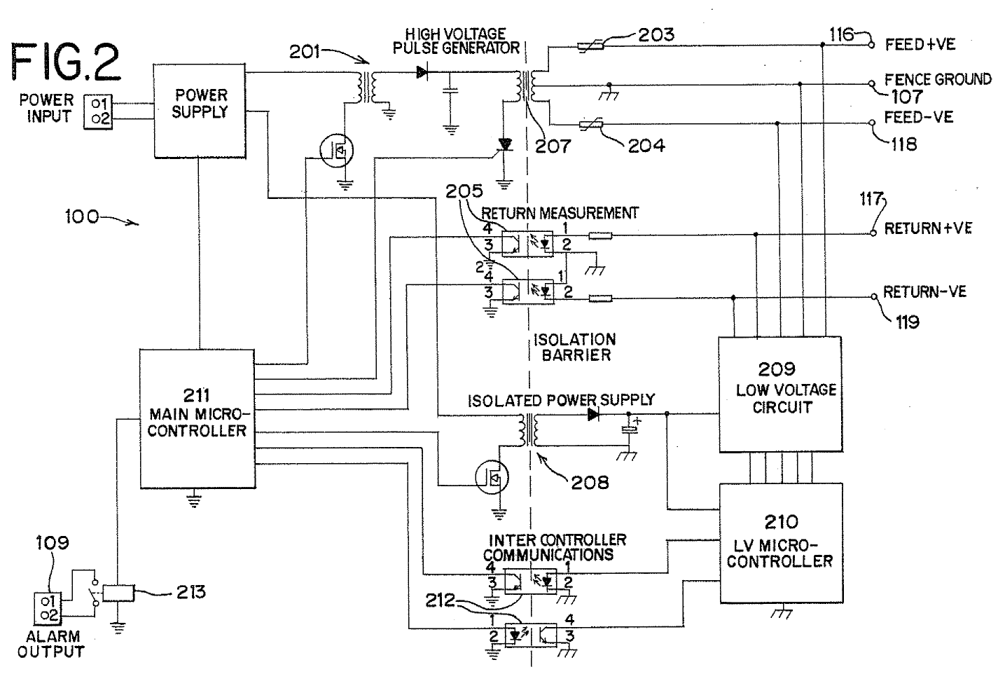

FIG. 2 is a simplified schematic diagram of a security electric fence energizer 100, according to an embodiment of the present invention.

The energizer 100 includes a capacitor discharge pulse generator 201 which is connected to the fence feed terminals 116 and 118 via a metal oxide varistors (MOVs) 203 and 204. The energizer 100 also includes a high voltage return peak voltage detection circuit 205 connected to the return terminals 117 and 119. Since the discharge step up transformer 207 in the capacitor discharge pulse generator 201 has a center-tapped output winding which is connected to ground 107, it generates two balanced and opposite polarity output pulses with respect to ground at the fence feed terminals 116 and 118.

The energizer 100 also includes an isolated power supply 208 to generate power for the low voltage detection circuit 209. The low voltage circuit 209 is also connected to the fence feed terminals 116 and 118 and to the fence return terminals 117 and 119.

Since the high voltage transformer 207 is decoupled from the fence feed terminals by MOVs 203 and 204, the low voltage signal source 209 is not loaded by the output transformer. The MOVs are chosen so that they present a high impedance at the voltage used by the low voltage circuit 209, yet cause minimal loss to the high voltage pulses. The low voltage system has a micro-controller 210 which is programmed to coordinate the activity of the low voltage system, to analyze the measurements from the fence returns 117 and 119 and to determine if the fence wires have been touched, cut or shorted. Microcontroller 210 communicates with a main controller 211 via serial communications lines that are optically isolated by optical isolators 212 to meet the requirements of safety standards. The main micro-controller 212 co-ordinates the activity of the high voltage pulse generator 201, and measures the returned peak voltages of the high voltage pulses via detection circuits 205. The main microcontroller 211 is programmed to analyze the results of these measurements as well as those passed to it from the low voltage system 209. If microcontroller 211 detects a problem with the fence 110, it generates an alarm via relay output 213. It may also communicate this alarm directly via sirens or to a building alarm system. The low voltage circuit 209 can be run both at the same time as, or instead of the high voltage generator 201.

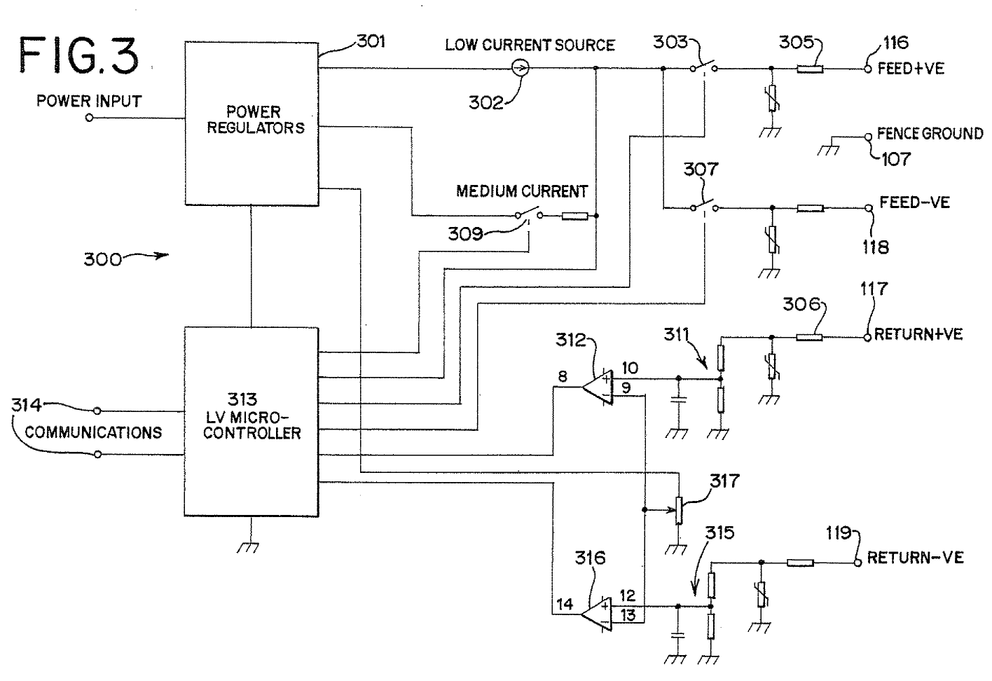

FIG. 3 is a simplified schematic of a low voltage intrusion detection system 300 according to another embodiment of the present invention. The system 300 includes a power supply 301 that supplies regulated voltage to a current source 302. The current source 302 is set to deliver a fixed small current such that, when it is applied to the fence wires 112 via switch 303 and fence feed terminal 116, it creates a voltage ramp (triangle wave) by charging the fence capacitance to ground. The time from zero to a specific voltage is proportional to capacitance of the fence wires 112. This is because Q=CV. Where Q is the charge on the capacitor, C is the effective capacitance of the fence and V is the voltage. Also Q=It where I is current and t is time. Substituting and rearranging gives us t=CV/I. For fixed voltage V and current I, time t is therefore proportional to capacitance C and the capacitance C can be measured by measuring the time taken by the voltage ramp to reach a pre-determined voltage. The capacitance will depend on the actual length of wire on the fence but is typically less than 0.1 uF. Using a current of approximately 1 milliamp and a voltage of less than 60 volts means that the measurement can be performed on the order 1 millisecond. This means that the system 300 can take readings up to two orders of magnitude faster than those that rely on the high voltage pulses.

Since the current source is low (about 1 mA) it is not affected by running out (feed) and back (return) through resistors 305 and 306, which form both the method of protection from high voltage and barriers required to be considered “intrinsically safe” under the UL913 standard. Also using a low current enhances the detection since, if leakage is increased, the available component of current I to charge the capacitor in the above equation is reduced, so the time t increases. Since someone touching the fence affects both the capacitance and leakage resistance, a change in the measurement, the rate of change with respect to time and the magnitude of the change can be compared with known data to determine if the fence is being touched.

The return wire is connected to the return terminal 117 where it is divided and filtered by the RC network 311 before being connected to a comparator 312. The low voltage system includes a microcontroller 313 which coordinates the switching on of the current source 302 via a switch 303 and times the elapsed time until the output of the comparator 312 goes high indicating a specific voltage has been achieved. If the operation times out indicating a possible short circuit on the fence, switch 309 is closed to attempt to drive the voltage up using a higher current. The microcontroller 313 can differentiate between an open circuit and a short circuit depending on the status of the voltage on the feed lines 116 and 118 which can be measured by a in built in analog to digital converter in the microcontroller 313. If the current source 309 is unable to drive the feed and return lines high 116 and 118, then the fence 110 has a short circuits or if the feed lines 116 and 118 are high while the return lines 117 and 119 are low, then it indicates an open circuit in one or more of the fence wires 112-113. RC network 315 and comparator 316 operate similarly to RC network 311 and comparator 312 to monitor return line 119. Both comparators 312 and 316 receive a reference voltage at their inverting input terminals from a variable resistor 317.

By incorporating switch 309, the system 300 can fall back to a simple continuity measurement if environmental conditions make capacitive measurement unworkable. Once the measurement on the positive lines 116-117 has been taken, switches 303 and 309 are opened and switch 307 is closed to start the voltage ramp on the second (negative) channel consisting of lines 118-119. The micro-controller 313 communicates the results of the measurements to a supervisory and control system via communications port 314.

The foregoing describes three embodiments of the present invention. Modifications, which will be apparent to those skilled in the art, can be made to these embodiments without departing from the scope of the present invention. For example, the fence 110 described in FIG. 1 need not be a bi-polar fence, but may be a conventional fence with one live set and one grounded set of wires.

The low voltage system described in FIG. 3 may measure the leakage and capacitance properties of the fence wires 112-113 by using a low voltage signal generated via a transformer, instead of directly coupled as shown in FIG. 3. Moreover, the capacitance of the fence wires may be measured using the fact that the impedance of a capacitor is related to the frequency of an applied AC signal. Alternately, the capacitance may be measured by means of an oscillator coupled to the fence wires so that the frequency of operation is affected by the capacitance of the fence.

The low voltage system 300 may use other characteristics of the fence wires 112-113 which are modified when touched by an intruder 402 such as inductance, transmission line delay, resonant frequency, quality factor, dissipation, impulse response, attenuation of high frequencies or affect on pulse shape of a conducted pulse.

The low voltage system 300 described in FIG. 3 may use the decay time from a fixed voltage to determine the time constant of the effective RC circuit comprising the fence capacitance Cp and its effective leakage resistance Rp. Moreover, if a known capacitance C and or resistance R is added, the measurement of the decay time yields a second time constant. The simultaneous equations can be solved to remove errors caused by fluctuating voltage and accurately and precisely yield the capacitance of the wires 112-113 of the fence 110 and their resistance to ground.

The energizer 100 described in FIG. 2 need not include a separate low voltage circuit 209 run from an isolated power supply 208, but rather generate low voltage pulses by applying a very low voltage to the primary of the main pulse generator step up transformer 207, thereby producing a series of low voltage pulses on the secondary winding. If suitably rated rectifiers are added in parallel to the MOVs 203 and 204 with which the output transformer 207 is connected to the feed wires 116 and 118, the pulse will rise normally but the fall or decay of the pulse will be decoupled from the transformer 207 and may be measured to determine the fence RC time constant of the wires 112-113 with respect to ground.

The energizer 100 described in FIG. 2 may include a different method to decouple the high voltage transformer 207 from the low voltage measuring system 209. The energizer 100 may include series capacitors which would pass the high frequencies of the high voltage pulse but block a low voltage, low frequency or DC capacitance measurement system.

Although the invention has been described with particular reference to energizers that are used for security fencing applications, it will be appreciated that the invention may be deployed with energizers that are used in other fencing applications, such as in agricultural fencing.

1. An energizer for an electric fence, said fence having a wire with a feed terminal and a return terminal for connection to said energizer, said energizer comprising:
a power supply;
a high voltage pulse generator for obtaining power from the power supply and for generating high voltage pulses at the feed terminal; and
a low voltage circuit for providing a low voltage signal at the feed terminal and for monitoring any changes in the low voltage signal at the return terminal to determine if the wire of the fence has been touched, or if the wire of the fence encounters a short circuit or an open circuit.

2. The energizer for an electric fence in accordance with claim 1, said energizer further comprising:
decoupling means disposed between the high voltage pulse generator and the low voltage circuit such that the high voltage pulses are not substantially reduced in voltage, and such that the low voltage circuitry is protected from the high voltage pulses.

3. The energizer for an electric fence in accordance with claim 2, wherein said decoupling means comprises an impedance.

4. The energizer for an electric fence in accordance with claim 3, wherein said impedance is a metal oxide varistor.

5. The energizer for an electric fence in accordance with claim 1, said energizer further comprising:
a controller to coordinate the monitoring of the low voltage signal by the low voltage circuit.

6. The energizer for an electric fence in accordance with claim 1, wherein the low voltage circuit makes measurements on the electrical characteristics of the wire of the electric fence between the high voltage pulses.

7. The energizer for an electric fence in accordance with claim 1, said energizer further comprising:
the high voltage pulse generator having a plurality of output terminals for connection to fences having a plurality of wires with a plurality of feed terminals and a plurality of return terminals; and
said low voltage circuit having a plurality of terminals for connection to fences having a plurality of wires with a plurality of feed terminals and a plurality of return terminals.

8. The energizer for an electric fence in accordance with claim 1, said energizer further comprising:
an isolated power supply for obtaining power from the power supply and for providing isolated power to said low voltage circuit.

9. A low voltage intrusion detection system for an electric fence, said fence having a wire with a feed terminal and a return terminal for connection to said energizer, said low voltage intrusion detection system comprising:
a current source for supplying a low current to the feed terminal;
a filter for receiving a return voltage signal at the return terminal and for supplying a filtered voltage signal;
a voltage comparator for receiving the filtered voltage signal and for providing an output signal if the filtered voltage signal exceeds a predetermined threshold voltage; and
a controller for receiving the output signal from the voltage comparator, for monitoring the voltage at the feed terminal, and for determining that a short circuit is present on the wire of the fence if the voltage at the feed terminal is low.

10. The low voltage intrusion detection system in accordance with claim 9, wherein the controller determines that an open circuit is present on the wire of the fence if the output signal from the voltage comparator is low, but the voltage at the feed terminal is high.

11. The low voltage intrusion detection system in accordance with claim 9, wherein the filter is a resistive-capacitive filter.

12. The low voltage intrusion detection system in accordance with claim 11, wherein the resistive capacitive filter also functions as a resistor divider to reduce the voltage at the return terminal before providing the filtered voltage signal to the voltage comparator.

13. The low voltage intrusion detection system in accordance with claim 9, said low voltage intrusion detection system comprising:
a medium current source for supplying a medium current to the feed terminal when the output signal from the comparator remains low, if the voltage at the feed terminal remains low, a short circuit exists on the wire of the fence.

14. A method of energizing an electric fence having a wire with a feed terminal and a return terminal for connection to an energizer, said method comprising the steps of:
generating high voltage pulses at the feed terminal with a high voltage pulse generator;
providing a low voltage signal at the feed terminal from a low voltage circuit; and
monitoring any changes in the low voltage signal at the return terminal, and the voltage at the feed terminal, to determine if the wire of the fence has been touched, or if the wire of the fence encounters a short circuit or an open circuit.

15. The method of energizing an electric fence in accordance with claim 14, said method comprising the further step of:
disposing decoupling means between the high voltage pulse generator and the low voltage circuit such that the high voltage pulses are not substantially reduced in voltage, and such that the low voltage circuitry is protected from the high voltage pulses.

16. The method of energizing an electric fence in accordance with claim 14, said method comprising the further step of:
coordinating the monitoring of the low voltage signal by the low voltage circuit with a controller.

17. The method of energizing an electric fence in accordance with claim 14, said method comprising the further step of:
making measurements on the electrical characteristics of the wire of the electric fence between the high voltage pulses.

18. The method of energizing an electric fence in accordance with claim 14, said method comprising the further step of:
providing isolated power to said low voltage circuit.

19. A method of detecting intrusion to an electric fence, said method comprising the steps of:
supplying a low current from a current source to a feed terminal for a wire in the fence;
receiving a return voltage signal at a return terminal of the wire;
filtering the return voltage signal to supply a filtered voltage signal;
comparing the filtered voltage signal to a predetermined voltage threshold;
providing an compared output signal if the filtered voltage signal exceeds the predetermined threshold voltage;
monitoring the voltage at the feed terminal; and
determining that a short circuit is present on the wire of the fence if the voltage at the feed terminal is low.

20. The method of detecting intrusion to an electric fence, said method comprising the further step of:
determining that an open circuit is present on the wire of the fence if the output signal from the voltage comparator is low, but the voltage at the feed terminal is high.

21. The method of detecting intrusion to an electric fence, said method comprising the further steps of:
supplying a medium current to the feed terminal when the compared output signal remains low; and
determining that a short circuit exists on the wire of the fence if the voltage at the feed terminal continues to remain low.
